(19) United States
(12) Patent Application Publication
(10) Pub. No.: US 2025/0353163 A1
(43) Pub. Date: Nov. 20, 2025

(54) Striking Tool

(71) Applicant: Milwaukee Electric Tool Corporation, Brookfield, WI (US)

(72) Inventor: Lucas M. Schmidt, Eagle, WI (US)

(21) Appl. No.: 19/098,755

(22) Filed: Apr. 2, 2025

Related U.S. Application Data
(60) Provisional application No. 63/648,859, filed on May 17, 2024.
(60) Provisional application No. 63/664,960, filed on Jun. 27, 2024.

(51) Int. Cl. B25G 3/12; B25G 1/01

(52) U.S. Cl. CPC B25G 3/12; B25G 1/01

(57) ABSTRACT

A striking tool is provided. The striking tool includes a handle, a head, and a shell. The handle includes a plurality of ridges positioned adjacent to a first end of the handle and extending circumferentially away from an external surface of the handle. The head is coupled to the first end of the handle and includes a through hole extending from a first side of the head to a second side of the head. The shell includes a plurality of grooves extending away from an interior surface of the shell. When the head is coupled to the first end of the handle, an exterior surface of the shell interfaces with an inner surface of the through hole, and the plurality of ridges of the handle receive and engage the plurality of grooves of the shell.

### CROSS-REFERENCE TO RELATED PATENT APPLICATIONS

The present application claims the benefit of and priority to U.S. Application No. 63/664,960, filed Jun. 27, 2024, and U.S. Application No. 63/648,859, filed May 17, 2024, which are incorporated herein by reference in their entireties.

### BACKGROUND OF THE INVENTION

The present invention relates generally to the field of tools. The present disclosure relates specifically to striking tools with a handle and head.

### SUMMARY OF THE INVENTION

One embodiment of the invention relates to a striking tool. The striking tool includes a handle, a head, and a shell. The handle is centered on and extends along a longitudinal axis. The handle includes a first end and a second end opposite the first end along the longitudinal axis. The handle further includes a plurality of ridges positioned adjacent to the first end of the handle. The plurality of ridges extends circumferentially from an external surface of the handle with respect to the longitudinal axis. The handle includes an insert surrounded by the external surface of the handle and extending between the first end and the second end. The head is coupled to the first end of the handle. The head includes a through hole extending from a first side of the head to a second side of the head opposite the first side. The shell includes a plurality of grooves extending away from an interior surface of the shell. The plurality of grooves is configured to engage the plurality of ridges. When the head is coupled to the first end of the handle, an exterior surface of the shell interfaces with an inner surface of the through hole, and the plurality of ridges receive and engage the plurality of grooves.

Another embodiment of the invention relates to a striking tool. The striking tool includes a handle and a head. The handle extends along a longitudinal axis. The handle includes a first end, a second end opposite the first end along the longitudinal axis, and an insert extending between the first end and the second end. The insert includes a flared portion positioned adjacent to the first end of the handle. The flared portion includes a third end, a fourth end opposite the third end along the longitudinal axis, and a middle section between the third end and the fourth end. The third end defines a first width, the fourth end defines a second width, and the middle section defines a third width. The first width and the second width are greater than the third width. The head is coupled to the first end of the handle, and the head surrounds the flared portion of the handle.

Another embodiment of the invention relates to a hammer. The hammer includes a handle, a head, and a shell. The handle extends along a longitudinal axis. The handle includes a first end, a second end opposite the first end along the longitudinal axis, and a plurality of rods extending between the first end of the handle and the second end of the handle. The handle further includes a first ridge and a second ridge. The first ridge is positioned adjacent to the first end of the handle and extends circumferentially away from an external surface of the handle with respect to the longitudinal axis. The second ridge extends circumferentially away from the external surface of the handle with respect to the longitudinal axis. The second ridge is spaced away from the first ridge in a direction towards the second end of the handle. The head is coupled to the first end of the handle. The head includes a through hole extends from a first side of the head to a second side of the head opposite the first side. The shell includes at least one groove extending away from an interior surface of the shell. When the head is coupled to the first end of the handle, an exterior surface of the shell interfaces with an inner surface of the through hole, and the at least one groove is engaged with and retained between the first ridge and the second ridge.

Additional features and advantages will be set forth in the detailed description which follows and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments. In addition, alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a side view of a striking tool with a handle insert shown in broken lines, according to an exemplary embodiment;

FIG. 2 is a perspective cross-sectional view of an end of the striking tool of FIG. 1 with a portion of a shell shown in broken lines, according to an exemplary embodiment;

FIG. 3 is a perspective view of a handle of the striking tool of FIG. 1, according to an exemplary embodiment;

FIG. 4 is a perspective cross-sectional view of an end of the handle of the striking tool of FIG. 1, according to an exemplary embodiment;

FIG. 5 is a perspective view of a handle insert of the striking tool of FIG. 1, according to an exemplary embodiment;

FIG. 6 is an exploded view of an end of the striking tool of FIG. 1 with the handle insert shown in broken lines, according to an exemplary embodiment;

FIG. 7 is a side view of a striking tool with a handle insert shown in broken lines, according to an exemplary embodiment;

FIG. 8 is a perspective cross-sectional view of an end of the striking tool of FIG. 7, according to an exemplary embodiment;

FIG. 9 is a perspective view of a handle of the striking tool of FIG. 7 with the handle insert shown in broken lines, according to an exemplary embodiment;

FIG. 10 is a perspective view of a handle of the striking tool of FIG. 7 from below with the handle insert shown in broken lines, according to an exemplary embodiment;

FIG. 11 is a perspective cross-sectional view of an end of the handle of the striking tool of FIG. 7, according to an exemplary embodiment;

FIG. 12 is a detailed view of an end of the striking tool of FIG. 7 with the handle insert shown in broken lines, according to an exemplary embodiment;

FIG. 13 is an exploded view of an end of the striking tool of FIG. 7, according to an exemplary embodiment;

FIG. 14 is a side view of a striking tool, according to an exemplary embodiment;

FIG. 15 is a perspective cross-sectional view of an end of the striking tool of FIG. 14 with a portion of a shell shown in broken lines, according to an exemplary embodiment;

FIG. 16 is a perspective view of a handle of the striking tool of FIG. 14, according to an exemplary embodiment;

FIG. 17 is an exploded view of an end of the striking tool of FIG. 14, according to an exemplary embodiment;

FIG. 18 is a side view of a striking tool, according to an exemplary embodiment;

FIG. 19 is a perspective cross-sectional view of an end of the striking tool of FIG. 18 with a portion of a shell shown in broken lines, according to an exemplary embodiment;

FIG. 20 is a side view of a striking tool, according to an exemplary embodiment;

FIG. 21 is a cross-sectional view of a handle of the striking tool of FIG. 20, according to an exemplary embodiment;

FIG. 22 is a cross-sectional view of an end of the handle of the striking tool of FIG. 20, according to an exemplary embodiment; and

FIG. 23 is a cross-sectional view of an end of the striking tool of FIG. 20, according to an exemplary embodiment.

### DETAILED DESCRIPTION

Referring generally to the figures, various embodiments of a striking tool are provided. As shown, various embodiments of a long handled striking tool, such as a sledgehammer, and related assembly methods are provided. In some embodiments described herein, the striking tool includes a coupling shell formed from two halves that encase an end of a handle of the striking tool. The head of the striking tool can then be pressed over the coupling shell and riveted to the coupling shell and handle to provide for a secure head to handle connection.

The striking tools described herein include handle inserts that provide structural stability to the handle during use. In specific embodiments, the striking tool includes a handle having an insert tube formed from a material including carbon fiber positioned around an insert core formed from fiberglass. In other embodiments, the insert tube is formed from a metal material, such as steel. The handle of the striking tool further includes a vibration dampening layer or coating around an end of the handle opposite the head of the striking tool. Applicant believes that this configuration provides improved overall handle durability, improved vibration dampening, and/or reduced costs to manufacture relative to some conventional striking tool designs.

Referring to FIGS. 1-3, a striking tool, shown as hammer 10, is shown, according to an exemplary embodiment. Hammer 10 includes a head 12 and a handle 14. Handle 14 is centered on and extends along a longitudinal axis 15 and includes a first end 16, a second end 18 opposite first end 16 along longitudinal axis 15, and a shaft 19 that extends between first end 16 and second end 18. Head 12 is coupled to first end 16 of handle 14. In a specific embodiment, head 12 is coupled to handle 14 via a friction fit, such as a press-fit connection.

As shown, handle 14 includes an outer handle housing 20 and a handle insert 22 located within handle housing 20. Handle insert 20 is surrounded by an external surface 50 of handle 14 and, more specifically, is surrounded by housing 20. In a specific embodiment, handle housing 20 is formed from a composite material, such as fiber-reinforced plastic. Handle insert 22 extends between first end 16 and second end 18. In a specific embodiment, handle insert 22 extends along the entire length of handle 14 from first end 16 to second end 18. In other specific embodiments, handle insert 22 extends less than the entire length of handle 14. Handle insert 22 includes a tube 24 and a core 26. Tube 24 surrounds core 26. In a specific embodiment, tube 24 is formed from a material including carbon fiber. Tube 24 can be a carbon fiber tube formed through a pulltrusion process. In another specific embodiment, tube 24 is formed from a polymer material, such as carbon fiber. Core 26 extends substantially the entire length of handle 14 along the direction of longitudinal axis 15. In a specific embodiment, core 26 is formed from a reinforced plastic material, such as fiber glass. Handle 14 also includes an alignment hole 27 that passes through both handle housing 20 and handle insert 22. Alignment hole 27 is configured to receive an alignment pin that secures the position of handle insert 22 relative to handle housing 20.

Hammer 10 further includes a coupling shell 28 formed from two shell halves 29. Coupling shell 28 includes a plurality of grooves 30 that are defined around an interior surface 52 of coupling shell 28. In particular, grooves 30 extend away from interior surface 52 of coupling shell 28. Handle 14 includes a plurality of ridges 31 that extend around external surface 50 of handle 14 proximate to first end 16. Plurality of ridges 31 are positioned adjacent to first end 16 of handle 14 and extend away from external surface 50 of handle 14. As shown, plurality of ridges 31 extend circumferentially from external surface 50 of handle 14 with respect to longitudinal axis 15. In some embodiments, ridges 31 extend around handle 14 in planes substantially perpendicular to longitudinal axis 15 such that ridges 31 extending in a direction perpendicular to longitudinal axis 15. As shown, handle insert 22 extends from second end 18 of handle 14 towards first end 16 and terminates adjacent to plurality of ridges 31. Specifically, handle insert 22 terminates adjacent to a ridge 31 positioned furthest from first end 16.

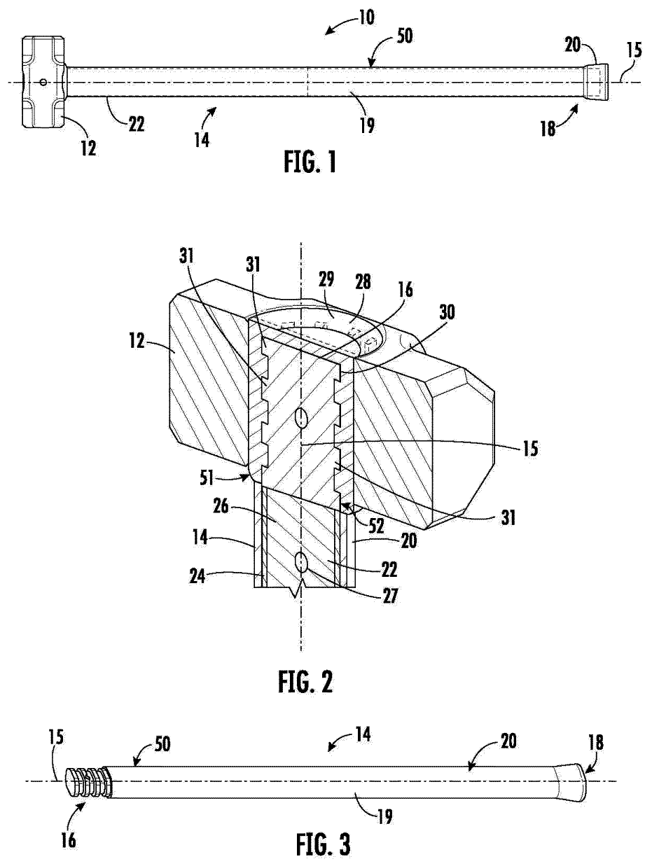

As shown in FIG. 2, shell halves 29 couple to handle 14 around first end 16 such that ridges 31 interlock with grooves 30 of coupling shell 28. Plurality of grooves 30 are configured to engage plurality of ridge 31. When head 12 is coupled to first end 16 of handle 14, interior surface 52 of coupling shell 28 engages external surface 50 of handle 14 and plurality of ridges 31 receive and retain plurality of grooves 30 facilitating the attachment of shell 28 and handle 14. In a specific embodiment, coupling shell 28 is formed from a thermoplastic material, such as glass fiber reinforced polyamide.

Referring to FIG. 3, an isolated view of handle 14 is shown, according to an exemplary embodiment. A portion of handle 14 near second end 18 flares as handle 14 extends away from first end 16 such that the width and/or depth (i.e., dimensions perpendicular to longitudinal axis 15) of handle 14 is greater near the second end 18 than at the first end 16 or along shaft 19. A portion of handle 14 near first end 16 has a width and/or depth (i.e., dimensions perpendicular to longitudinal axis 15) that is narrower near first end 16 than at the second end 18 or along shaft 19. In a specific embodiment, the dimensions perpendicular to longitudinal axis 15 at the ridges of handle 14 are narrower than at the shaft 19 of handle 14.

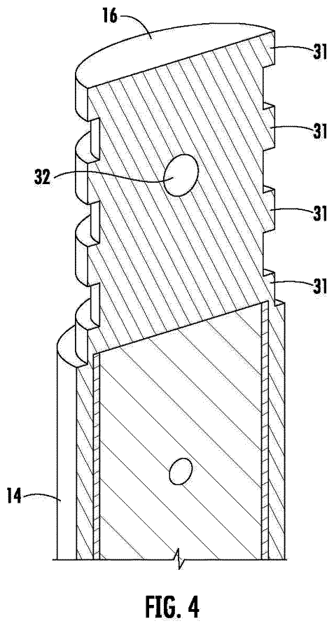

As shown in FIG. 4, in some embodiments, first end 16 of handle 14 includes at least four ridges 31. Ridges 31 are spaced apart from each other along external surface 50 of handle 14. Ridges 31 are spaced along the length of handle 14 and are located adjacent to first end 16 along the length of handle 14. A first ridge 31 is positioned adjacent to first end 16, and other ridges 31 are spaced away from first ridge 31 in a direction towards second end 18 of handle 14 along longitudinal axis 15. The portions of handle 14 between ridges 31 with respect to the direction of longitudinal axis 15 have a reduced radius relative to portions of handle 14 extended by ridges 31. This configuration allows for first end 16 to receive portions, such as grooves 30, of shell halves 29 in the space between ridges 31, providing a secure connection between handle 14 and shell halves 29. In this way, grooves 30 positioned within the space between ridges 31 may be engaged and retained between adjacent ridges 31. In a specific embodiment, first end 16 of handle 14 includes a handle opening 32 configured to receive and retain a fastener to further secure handle 14 to shell halves 29 and head 12.

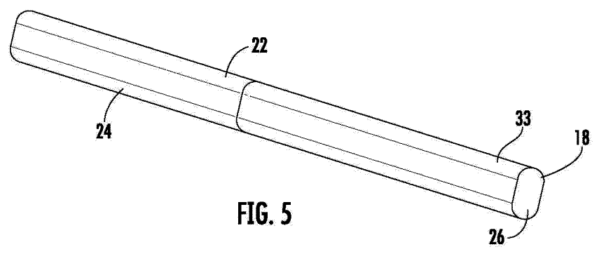

Referring to FIG. 5, an isolated view of handle insert 22 is shown, according to an exemplary embodiment. Handle insert 22 further includes an outer layer or vibration dampening layer 33 around insert tube 24. Vibration dampening layer 33 surrounds tube 23. Vibration dampening layer 33 is positioned adjacent to second end 18 and is configured to reduce vibrations transmitted along handle 14 to a user when hammer 10 is used to strike a workpiece. Vibration dampening layer 33 can be formed from an elastomer, such as urethane. In a specific embodiment, vibration dampening layer 33 is formed from foamed urethane. In some embodiments, vibration dampening layer 33 is molded on to handle insert 22. In other embodiments, vibration dampening layer 33 is molded separately as a tube and rolled onto handle insert 22. In further embodiments, vibration dampening layer 33 is molded as a separate flat component and adhered around handle insert 22.

Vibration dampening layer 33 extends around a portion of handle insert 22 proximate to second end 18. Vibration dampening layer 33 reduces or dampens the intensity of vibrations transmitted from handle insert 22 through handle 14 and to a user's hands when head 12 strikes an object. Applicant believes that the configuration of insert tube 24, insert core 26, and vibration dampening layer 33 provides hammer 10 with a handle that is more durable and lighter weight than the handles of some conventional striking tools.

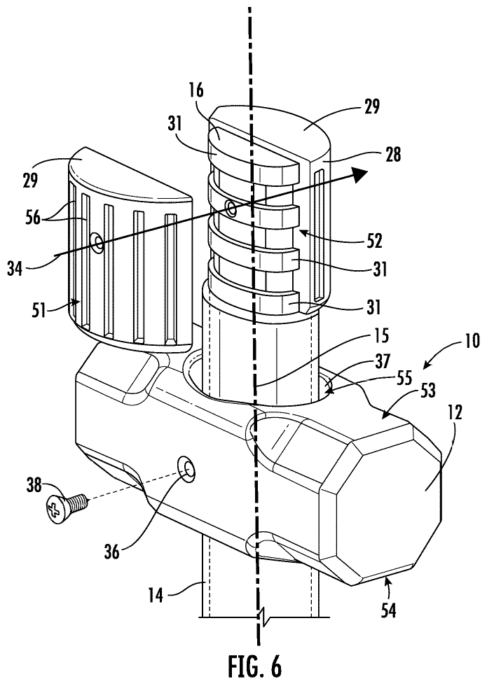

Referring to FIG. 6, an exploded view of hammer 10 near first end 16 of handle 14 is shown, according to an exemplary embodiment. Coupling shell 28 includes a plurality of recesses 56 that extend along an exterior surface 51 of shell 28. As shown, recesses 56 extend in a direction substantially parallel to longitudinal axis 15. Shell halves 29 each include a shell opening 34 that extends in a direction substantially perpendicular to longitudinal axis 15 when hammer 10 is assembled. Head 12 includes a head rivet opening 36 that extends in a direction substantially perpendicular to longitudinal axis 15 when head 12 is coupled to handle 14. Head 12 further includes a through-hole 37 that extends from a first side or top side 53 of head 12 to a second side or bottom side 54 of head opposite top side 53. Through hole 37 is parallel to longitudinal axis 15. As shown in FIG. 6, hammer 10 includes one or more rivets 38.

To assemble hammer 10, handle 14 is inserted into through-hole 37 from a bottom side of head 12 such that first end 16 extends out of a top side of head 12. Shell halves 29 are coupled to first end 16 of handle 14 such that ridges 31 of handle 14 are received in grooves 30 of shell halves 29. In a specific embodiment, coupling shell 28 extends entirely around and covers first end 16 of handle 14 such that coupling shell 28 entirely surrounds and encloses first end 16 of handle 14. Head 12 is then pressed over coupling shell 28 such that coupling shell 28 and first end 16 of handle 14 are retained within through-hole 37 of head 12 via a press-fit connection. Exterior surface 51 of coupling shell 28 interfaces with an inner surface 55 of through-hole 37 and plurality of grooves 30 engage with plurality of ridges 31. In this way, head 12 is coupled to handle 14. When head 12 is pressed over coupling shell 28, handle opening 32, shell opening 34, and head rivet opening 36 are each aligned with one another. A fastener, such as rivet 38, extends through each of handle opening 32, shell opening 34, and head rivet opening 36 to securely couple head 12 to handle 14 and coupling shell 28. Applicant believes that this configuration provides for a striking tool with a more secure and durable connection between the handle and striking head than some conventional striking tools.

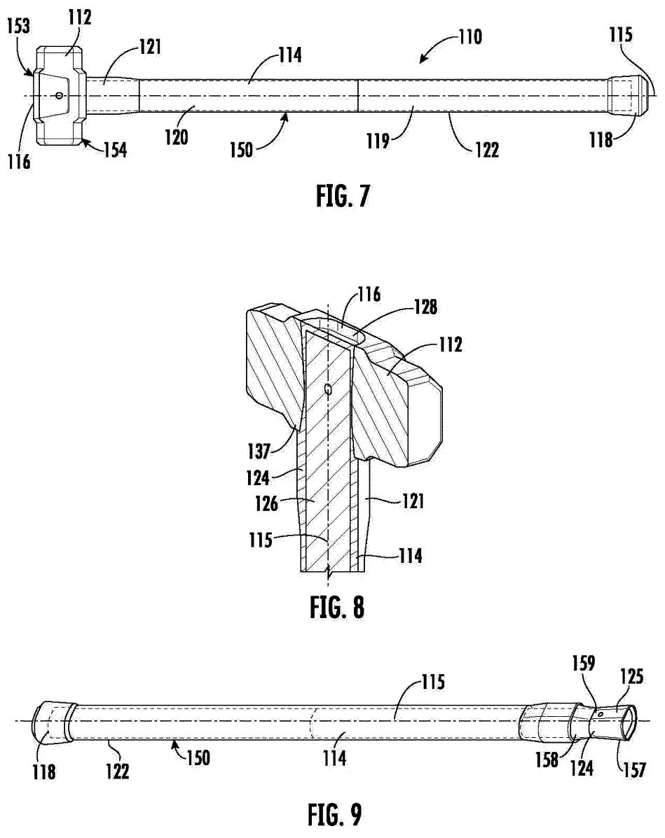

Referring to FIG. 7, a front-side view of a striking tool, shown as hammer 110, is shown, according to an exemplary embodiment. Hammer 110 is similar to hammer 10, except for the differences described. Hammer 110 includes a head 112 and a handle 114 extending along a longitudinal axis 115, handle 114 having a first end 116, a second end 118 opposite first end 116 along longitudinal axis 115, and a shaft 119 extending between first end 116 and second end 118. In a specific embodiment, hammer 110 includes a handle housing 120 substantially similar to handle housing 20, except for the differences discussed herein. Specifically, handle housing 120 includes an overstrike guard 121 and a flared portion 125.

Hammer 110 includes overstrike guard 121. Overstrike guard 121 forms a portion of handle housing 120 of handle 114. Overstrike guard 121 is located proximate to first end 116 of handle 114, below head 112 (i.e., between head 112 and second end 118 of handle 114) when hammer 110 is assembled. Overstrike guard 121 increases the radial width of handle 114 with respect to longitudinal axis 115 relative to the shaft 119. In a specific embodiment, overstrike guard 121 is overmolded onto handle 114. In some embodiments, overstrike guard 121 is formed from a rubber material, such as thermoplastic vulcanizate.

As shown in FIG. 8, handle 114 includes an endcap 128 that covers first end 116 of handle 114. Endcap 128 flares radially outward from longitudinal axis 115 as endcap 128 extends away from second end 118. A portion of overstrike guard 121 narrows as overstrike guard 121 extends toward first end 116. In some embodiments, endcap 128 is formed from a rubber material, such as thermoplastic vulcanizate.

Head 112 includes a through-hole 137 extending from a first side or top side 153 to a second side or bottom side 154 opposite top side 153. Through-hole 137 of head 112 is shaped such that through-hole 137 narrows near the center of head 112. As such, a radial distance from longitudinal axis 115 to the portions of head 112 defining through-hole 137 is greater near top side 153 of head 112 that is closest to first end 116 of handle 114 than at a point between top side 153 and bottom side 154 of head 112. Similarly, a radial distance from longitudinal axis 115 to the portions of head 112 defining through-hole 137 is greater near bottom side 154 of head 112 that is closest to the second end 118 of handle 114 than at a point between top side 153 and bottom side 154 of head 112.

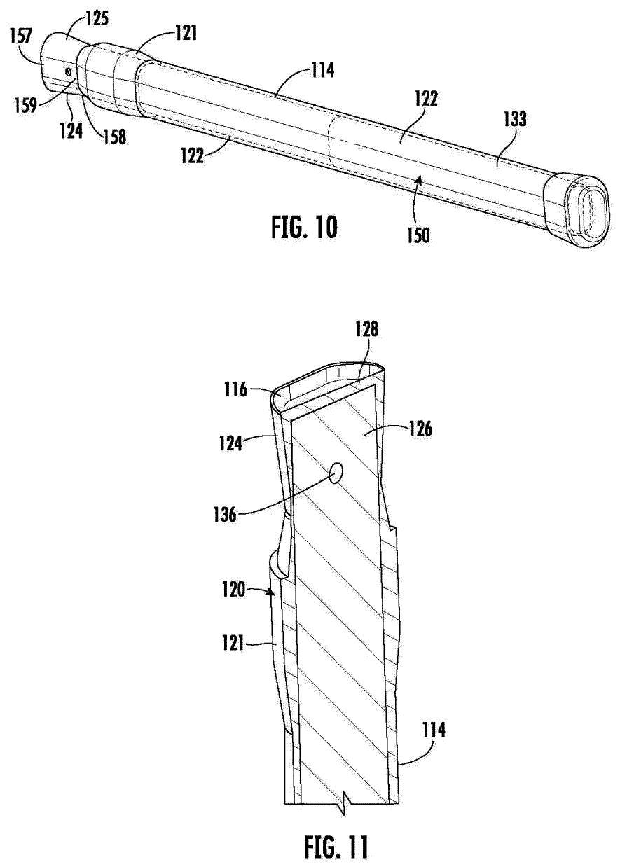

Referring to FIGS. 9-10, an isolated view of handle 114 is shown, according to an exemplary embodiment. Handle 114 includes a handle insert 122 with an insert tube 124 and an insert core 126. Handle insert 122, and specifically insert tube 124, of handle 114 includes a flared portion 125 at first end 116. Flared portion 125 is shaped such that the radial distance of tube 124 from longitudinal axis 115 increases as flared portion 125 extends away from second end 118 of handle 114. Flared portion 125 includes a third end 157, a fourth end 158 opposite third end 157, and a middle section 159 between third end 157 and fourth end 158. Flared portion 125 narrows at middle section 159. The width of flared portion 125 decreases from third end 157 to middle section 159 and the width of flared portion 125 decreases from fourth end 158 to middle section 159. In a specific embodiment, a first width at third end 157 and a second width at fourth end 158 are both greater than a third width at middle section 159. In a specific embodiment, insert tube 124 is formed from a metal material, such as steel. Insert tube 124 can be formed from an extrusion process such that insert tube 124 is an extruded steel tube. In a specific embodiment, flared portion 125 is created in insert tube 124 via a press operation.

As shown in FIG. 10, overstrike guard 121 is positioned between flared portion 125 and second end 118 of handle 114. Overstrike guard 121 and flared portion 125 of insert tube 124 are shaped such that the width of handle 114 decreases between overstrike guard 121 and flared portion 125 to form a narrow portion of handle 114. In particular, a guard width of the guard portion is greater than the first width at third end 157 of flared portion 125, the second width at fourth end 158 of flared portion 125, and the third width at middle section 159 of flared portion 125. Handle insert 122 includes a vibration dampening layer 133 that is substantially similar to the vibration dampening layer 33 of handle 14.

As shown in FIG. 11, endcap 128 is located at first end 116 of handle 114 between insert core 126 and flared portion 125 of insert tube 124. Handle 114 includes a handle opening 136 that extends through insert core 126, insert tube 124, and endcap 128.

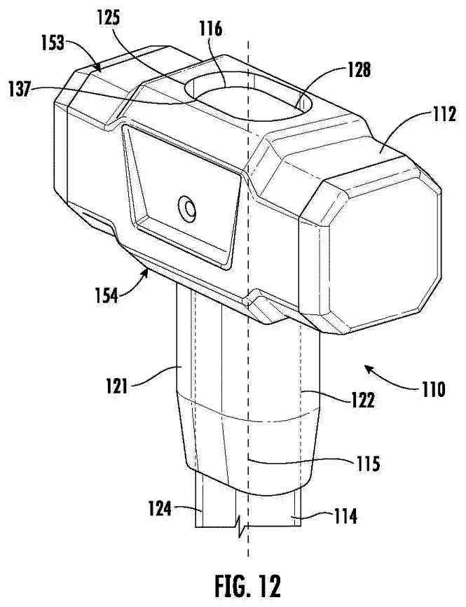

Referring to FIG. 12, a perspective view of hammer 110 near head 112 and first end 116 of handle 114 is shown, according to an exemplary embodiment. A portion of overstrike guard 121 has a greater width than the narrowest portion of through-hole 137 of head 112. A portion of flared portion 125 of insert tube 124 has a greater width than the narrowest portion of through-hole 137 of head 112. Handle 114 and head 112 are configured such that, when hammer 110 is assembled, overstrike guard 121 and flared portion 125 along with endcap 128 cooperate to securely retain head 112 around handle 114 such that head 112 is restricted from moving relative to handle 114 in the direction of longitudinal axis 115.

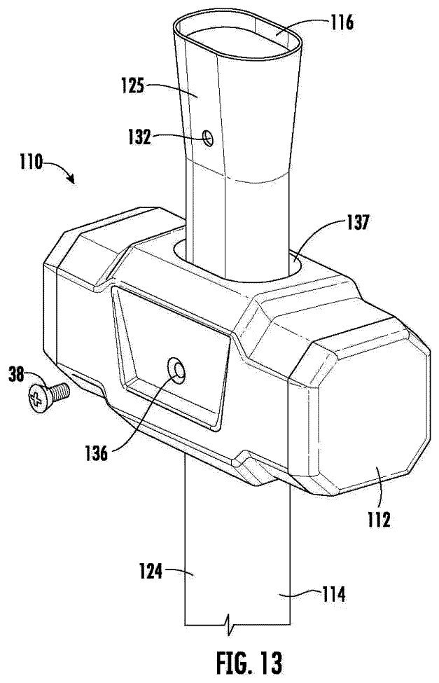

Referring to FIG. 13, an exploded view of hammer 110 is shown, according to an exemplary embodiment. Handle 114 includes a handle opening 132 configured to receive a fastener, such as rivet 38. Head 112 includes a head rivet opening 136 configured to receive a fastener, such as rivet 38.

To assemble hammer 110, handle 114 is inserted into through-hole 137 from a bottom side of head 112 such that first end 116 extends out of a top side of head 112. Head 112 is then pressed over flared portion 125 of insert tube 124 such that first end 116 of handle 114 is retained within through-hole 137 of head 112 and flared portion 125 is surrounded by head 112. When head 112 is pressed over flared portion 125, handle opening 132 and head rivet opening 136 are each aligned with one another. A fastener, such as rivet 38, extends through each of handle opening 132 and head rivet opening 136 to securely couple head 112 to handle 114. Applicant believes that this configuration provides for a striking tool with a more secure and durable connection between the handle and striking head than some conventional striking tools. In various embodiments, head 112 is coupled to handle via a press-fit connection.

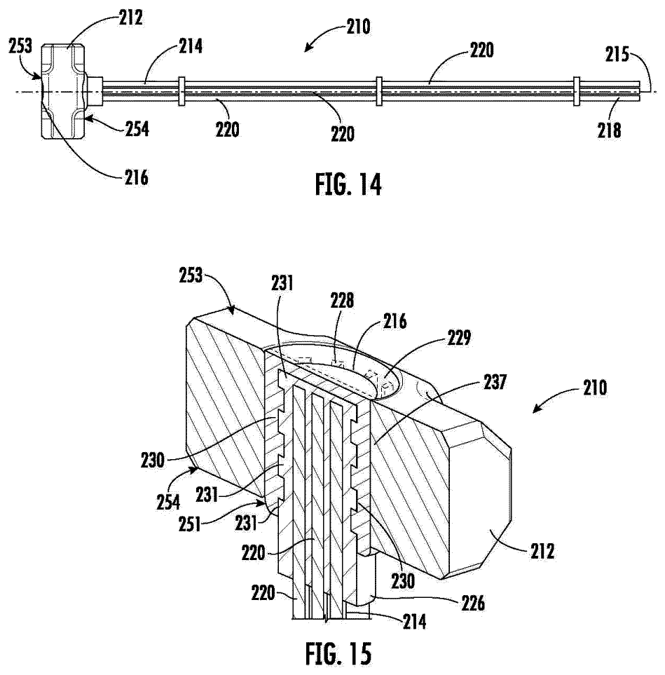

Referring to FIG. 14, a front-side view of a striking tool, shown as hammer 210, is shown, according to an exemplary embodiment. Hammer 210 is similar to hammer 10, except for the differences described. Hammer 210 includes a head 212 and a handle 214 having a first end 216 and a second end 218. Handle 214 extends along a longitudinal axis 215 between first end 216 and second end 218. In a specific embodiment, hammer 210 includes a handle housing substantially similar to handle housing 20. The handle housing of hammer 210 can be formed from a rubber material, such as thermoplastic vulcanizate.

Handle 214 includes a plurality of rods 220 extending between first end 216 and second end 218 of handle 214. Rods 220 extend substantially the entire length of hammer 210 along longitudinal axis 215. In a specific embodiment, plurality of rods 220 extend along the entire length of handle 214 from first end 216 to second end 218. As shown, handle 214 includes six (6) rods. In particular, plurality of rods 220 define two (2) rows of rods and each row of rods includes at least three (3) rods. In other embodiments, handle 214 includes less than six rods. Rods 220 are formed from a material including carbon fiber. In a specific embodiment, rods 220 are formed through a pulltrusion process. The material of rods 220 is bonded with a thermal plastic, such as nylon.

As shown in FIG. 15, hammer 210 includes a handle cap 226 at first end 216 of handle 214, a coupling shell 228, and a through-hole 237 extending through head 212. Coupling shell 228 is formed from two shell halves 229. Coupling shell 228 includes a plurality of grooves 230 that are defined around an interior surface of coupling shell 228. Handle cap 226 includes a plurality of ridges 231 around an external surface of handle cap 226. An end of each rod 220 is positioned inside of handle cap 226 such that each rod 220 is coupled to handle cap 226. In a specific embodiment, handle cap 226 is formed from a glass fiber reinforced polyamide material, such as PA6-GF or glass fiber reinforced nylon 6. In some embodiments, coupling shell 228 is formed from a glass fiber reinforced polyamide material, such as PA6-GF or glass fiber reinforced nylon 6.

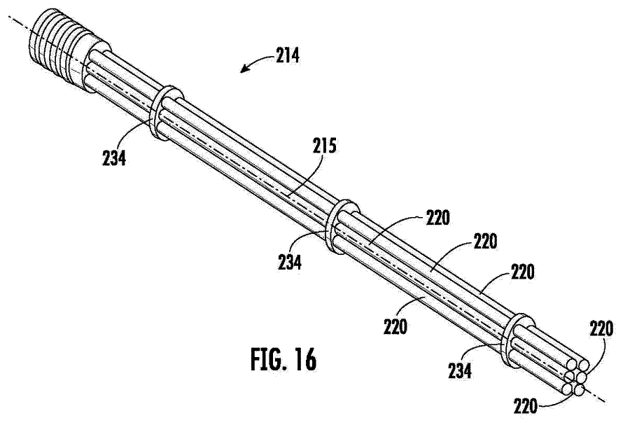

Referring to FIG. 16, hammer 210 includes a plurality of collars 234 around handle 214 and spaced apart from each other along longitudinal axis 215. Collars 234 surround plurality of rods 220. Rods 220 pass through and are retained by collars 234. Each collar 234 in the plurality of collars 234 is spaced apart from adjacent collars 234 along the length of the handle in a direction along the longitudinal axis. In a specific embodiment, collars 234 are formed from a glass fiber reinforced polyamide material, such as PA6-GF or glass fiber reinforced nylon 6. Collars 234 disperse stresses (i.e., tension and compression) experienced by rods 220 between each of the rods. Collars 234 further provide structural support to rods 220, reducing or preventing deflection of rods 220 within the handle housing of handle 214 during assembly, such as during injection molding of the handle housing or of handle cap 226.

Referring to FIG. 17, an exploded view of hammer 210 is shown, according to an exemplary embodiment. To assemble hammer 210, first end 216 is inserted into through-hole 237 of head 212 such that handle cap 226 extends away from a top surface of head 212. Shell halves 229 are assembled around handle cap 226 to form coupling shell 228. Shell halves 229 couple to handle 214 around handle cap 226 at first end 216 such that ridges 231 interlock with grooves 230 of coupling shell 228. Head 212 is then pressed over coupling shell 228 such that head 212 is coupled to handle 214 via a press-fit connection. The press-fit connection between coupling shell 228 and head 212 restricts relative motion of head 212 with respect to handle 214 in the direction away from second end 218 along longitudinal axis 215. In a specific embodiment, hammer 210 includes an overstrike guard molding below head 212 when assembled. The overstrike guard molding restricts relative motion of head 212 with respect to handle 214 in the direction toward second end 218 along longitudinal axis 215.

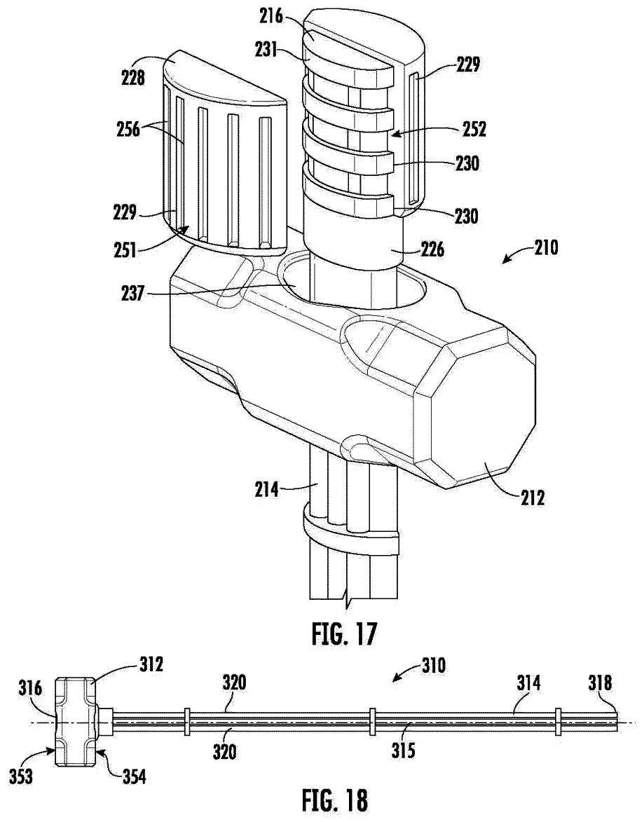

Referring to FIG. 18, a front-side view of a striking tool, shown as hammer 310, is shown, according to an exemplary embodiment. Hammer 310 is similar to hammer 210, except for the differences described. Hammer 310 includes a head 312 and a handle 314. Handle 314 extends along a longitudinal axis 315 and includes a first end 316 and a second end 318 opposite first end 316 along longitudinal axis 315. Handle 314 includes a plurality of rods 320 that extend substantially the entire length of handle 314 along longitudinal axis 315. Rods 320 are formed through a pulltrusion process. In a specific embodiment, rods 320 are formed from a material including fiberglass. In further embodiments, rods 320 are formed from a composite material including fiberglass and carbon fiber. Applicant believes that incorporating carbon fiber in rods 320 provides rods 320 with increased rigidity relative to rods including fiberglass without carbon fiber.

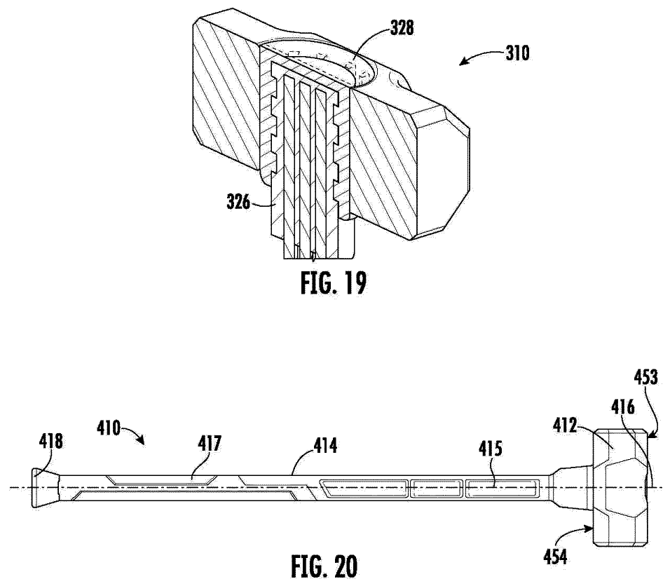

Referring to FIG. 19, a cross-sectional view of hammer 310 is shown, according to an exemplary embodiment. Hammer 310 includes a handle cap 326 and a coupling shell 328. Hammer 310 is assembled in substantially the same manner as described above with respect to hammer 210.

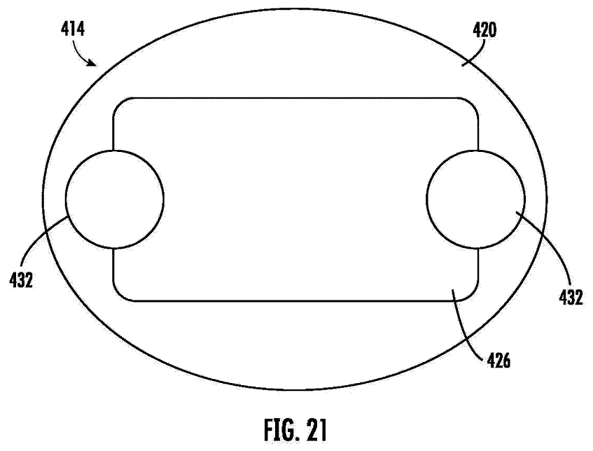

Referring to FIG. 20, a front-side view of a striking tool, shown as hammer 410, is shown, according to an exemplary embodiment. Hammer 410 is similar to hammer 10, except for the differences described. Hammer 410 includes a head 412 and a handle 414. Handle 414 extends along a longitudinal axis 415 and includes a first end 416 and a second end 418 opposite first end 416 along longitudinal axis 415. Handle 414 includes a grip portion 417 near second end 418.

Referring to FIG. 21, a cross-sectional view of handle 414 is shown, according to an exemplary embodiment. Handle 414 includes a handle housing 420, a handle core 426, and a plurality of support bars 432. In a specific embodiment, handle 414 includes two (2) support bars 432. Handle core 426 and support bars 432 extend within handle 414 along longitudinal axis 415. Support bars 432 are positioned on opposite sides of handle core 426 with respect to each other such that handle core 426 is between support bars 432. Support bars 432 extend the entire length of handle 414 from first end 416 to second end 418. In some embodiments, support bars 432 have a diameter of between 5 mm and 10 mm, or specifically between 6 mm and 8 mm, or specifically about 8 mm. In some embodiments, handle core 426 has a width in a first direction perpendicular to longitudinal axis 415 of between 15 mm and 35 mm, or specifically between 20 mm and 30 mm, or specifically between 24 mm and 26 mm. In further embodiments, handle core 426 has a width in a second direction perpendicular to longitudinal axis 415 and the first direction of between 5 mm and 25 mm, or specifically between 10 mm and 20 mm, or specifically about 14 mm.

In a specific embodiment, handle housing 420 is formed from a composite material, such as fiberglass reinforced plastic. Handle core 426 is formed from a material including fiberglass. Support bars 432 are formed from a metal material, such as steel. In a specific embodiment, support bars 432 are formed from 1080 carbon steel. In some embodiments, support bars 432 are formed from 2cr12 steel.

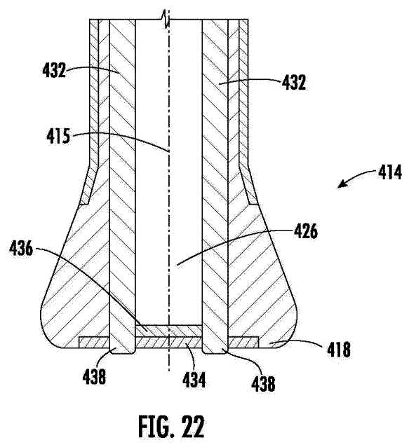

Referring to FIG. 22, a cross-sectional view of second end 418 of handle 414 is shown, according to an exemplary embodiment. Second end 418 of handle 414 includes an end plate 434, an internal layer 436, and a plurality of rivets 438. End plate 434 forms an external surface of handle 414 at second end 418. Internal layer 436 is positioned between handle core 426 and end plate 434 along longitudinal axis 415. Internal layer 436 is positioned between support bars 432. Support bars 432 extend through end plate 434. Support bars 432 couple to rivets 438 to couple end plate 434 to handle 414. In some embodiments, support bars 432 are integrally formed with rivets 438 such that support bars 432 rivet end plate 434 to handle 414.

In a specific embodiment, end plate 434 has a thickness in the direction of longitudinal axis 415 of between 1 mm and 10 mm. End plate 434 can have a thickness of between 2 mm and 5 mm. In some embodiments, End plate 434 has a thickness of about 3 mm. End plate 434 is formed from a metal material, such as stainless steel. Internal layer 436 is formed from a thermoplastic material, such as thermoplastic elastomer or thermoplastic rubber.

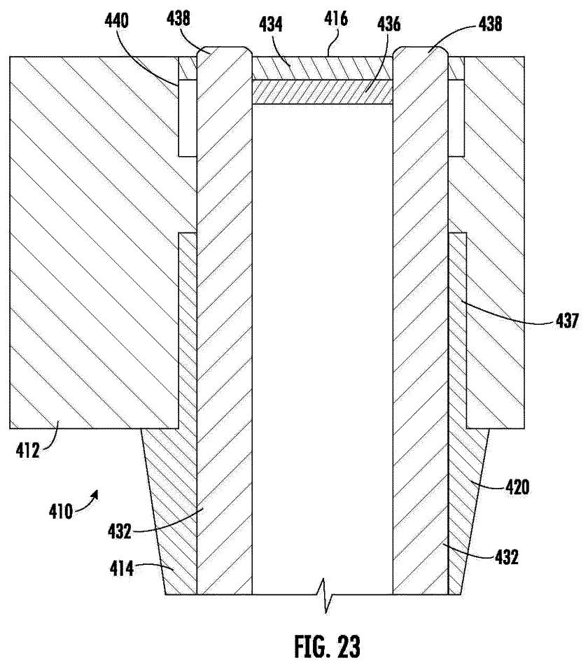

Referring to FIG. 23, a cross-sectional view of first end 416 of handle 414 is shown, according to an exemplary embodiment. Hammer 410 includes a head through-hole 437 within head 412 and a first end assembly 440 within head through-hole 437 that includes an end plate 434, an internal layer 436, and a plurality of rivets 438. A portion of handle housing 420 extends within head through-hole 437. In a specific embodiment, an end of handle housing 420 is spaced apart from first end assembly 440 by between 5 mm and 20 mm, or specifically between 7 mm and 15 mm, or specifically about 10 mm. In a specific embodiment, end plate 434, internal layer 436, and rivets 438 at first end 416 are substantially similar to End plate 434, internal layer 436, and rivets 438 at second end 418 as described above. In some embodiments, support bars 432 are integrally formed with rivets 438 such that support bars 432 serve as rivets that couple head 412 to handle 414.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes, and omissions may also be made in the design, operating conditions, and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths, and radii, as shown in the Figures are to scale. Actual measurements of the Figures will disclose relative dimensions, angles, and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A striking tool, comprising:
a handle centered on and extending along a longitudinal axis, the handle comprising:
a first end;
a second end opposite the first end along the longitudinal axis;
a plurality of ridges positioned adjacent to the first end of the handle, the plurality of ridges extending circumferentially from an external surface of the handle with respect to the longitudinal axis;
an insert surrounded by the external surface of the handle and extending between the first end and the second end;
a head coupled to the first end of the handle, the head comprising a through hole extending from a first side of the head to a second side of the head opposite the first side; and
a shell comprising a plurality of grooves extending away from an interior surface of the shell, the plurality of grooves configured engage the plurality of ridges, wherein, when the head is coupled to the first end of the handle, an exterior surface of the shell interfaces with an inner surface of the through hole, and the plurality of ridges receive and engage the plurality of grooves.

2. The striking tool of claim 1, wherein the shell entirely surrounds and encloses the first end of the handle.

3. The striking tool of claim 1, wherein the exterior surface of the shell includes a plurality of recesses that extend in a direction parallel to the longitudinal axis.

4. The striking tool of claim 1, wherein the plurality of ridges extends in a direction perpendicular to the longitudinal axis.

5. The striking tool of claim 1, wherein the insert extends along the entire length of the handle from the first end to the second end.

6. The striking tool of claim 1, wherein the insert extends from the second end of the handle towards the first end and terminates adjacent to the plurality of ridges.

7. The striking tool of claim 1, wherein the insert comprises a core and a tube surrounding the core.

8. The striking tool of claim 7, wherein the core is formed from fiber glass, and the tube is formed from carbon fiber.

9. The striking tool of claim 7, wherein the insert further comprises an outer layer surrounding the tube, wherein the outer layer is positioned adjacent to the second end of the handle and is configured to dampen vibrations transmitted along the handle when the striking tool is used to strike a workpiece.

10. The striking tool of claim 1, wherein the head is coupled to the handle via a press-fit connection.

11. A striking tool, comprising:
a handle extending along a longitudinal axis, the handle comprising:
a first end;
a second end opposite the first end along the longitudinal axis;
an insert extending between the first end and the second end, the insert comprising a flared portion positioned adjacent to the first end of the handle, the flared portion comprising a third end, a fourth end opposite the third end along the longitudinal axis, and a middle section between the third end and the fourth end, wherein the third end defines a first width, the fourth end defines a second width, and wherein the middle section defines a third width, and wherein the first width and the second width are greater than the third width; and
a head coupled to the first end of the handle, wherein the head surrounds the flared portion of the handle.

12. The striking tool of claim 11, wherein the head comprises a through hole extending from a first side of the head to a second side of the head opposite the first side, wherein a radial distance from the longitudinal axis to an inner surface of the through hole is greater near the second side of the head than at a point between the first side of the head and the second side of the head.

13. The striking tool of claim 12, wherein a radial distance from the longitudinal axis to the inner surface of the through hole is greater near the first side of the head than at a point between the first side of the head and the second side of the head.

14. The striking tool of claim 11, wherein the handle further comprises a housing surrounding the insert, wherein the housing comprises a guard positioned between the flared portion and the second end of the handle along the longitudinal axis.

15. The striking tool of claim 14, wherein the guard defines a guard width, wherein the guard width is greater than the first width, the second width, and the third width of the flared portion.

16. The striking tool of claim 11, wherein the head is coupled to the handle via a press-fit connection.

17. A hammer, comprising:
a handle extending along a longitudinal axis, the handle comprising:
a first end;
a second end opposite the first end along the longitudinal axis;
a first ridge positioned adjacent to the first end of the handle and extending circumferentially away from an external surface of the handle with respect to the longitudinal axis;
a second ridge extending circumferentially away from the external surface of the handle with respect to the longitudinal axis, the second ridge spaced away from the first ridge in a direction towards the second end of the handle;
a plurality of rods extending between the first end of the handle and the second end of the handle;
a head coupled to the first end of the handle, the head comprising a through hole extending from a first side of the head to a second side of the head opposite the first side; and
a shell comprising at least one groove extending away from an interior surface of the shell, wherein, when the head is coupled to the first end of the handle, an exterior surface of the shell interfaces with an inner surface of the through hole, and the at least one groove is engaged with and retained between the first ridge and the second ridge.

18. The hammer of claim 17, wherein the plurality of rods extends along the entire length of the handle from the first end to the second end.

19. The hammer of claim 17, wherein the plurality of rods defines two rows of rods.

20. The hammer of claim 17, wherein the handle further comprises a plurality of collars, wherein the plurality of rods pass through and are surrounded by the plurality of collars.
